(19) United States
(12) Patent Application Publication
(10) Pub. No.: US 2012/0278471 A1
(43) Pub. Date: Nov. 1, 2012

(54) Devices and Methods for Two Step Searches for Servers by a Communication Device

(75) Inventors: Michael P. Labowicz, Palatine, IL (US); Bin Li, Beijing (CN); Ping-Yan Su, Beijing (CN); Yi-Qiang Zhai, Beijing (CN)

(73) Assignee: Motorola Mobility, Inc., Libertyville, IL (US)

(21) Appl. No.: 13/094,205

(22) Filed: Apr. 26, 2011

(51) Int. Cl. G06F 15/173

(52) U.S. Cl. 709/224

(57) ABSTRACT

Disclosed are a communication device and a method of a communication device that includes processing by the controller a first scan for shared drives and folders on a wide local area network in accordance with a CIFS Protocol and then processing a second scan for shared drives and folders of a local wide area network in accordance with an Address Resolution Protocol. An Address Resolution Protocol (ARP) is a computer network host's link layer or hardware address when only it's Internet Layer (IP) or Network Layer address is known. An ARP port scan is a low level request and answer protocol that uses a simple message format that contains one address resolution request or response. IP addresses are the result of an ARP port scan. In this way, user can be provided with the opportunity to connect to all available local servers.

### FIELD OF THE INVENTION

Disclosed are devices and method for two step searches for servers of local networks by a communication device, and more particularly where the two step search includes searches under the Common Internet File System (CIFS) Protocol and the Address Resolution Protocol (ARP).

### BACKGROUND

Communication devices most often are configured for wireless communication with Wide Local Area Networks (WLANs) such as Wifis. The Common Internet File System (CIFS) is the standard manner in which communication devices share files across intranets and the Internet. CIFS defines a remote file-access protocol that is compatible with the manner in which applications share data on local disks and network file servers. CIFS utilizes the Internet's global Domain Naming Service (DNS). File names can be in any character set, not just character sets designed for English or Western European languages.

When a communication device receives a response from a remote device of a scanned WLAN, the remote device's host name can be annunciated by the communication device. For example, upon scanning for domains, and then scanning for servers, if available shared drives and folders are determined, the servers' host names can be listed on the communication device's display. A user may select a server which may further require authentication for connection.

### BRIEF DESCRIPTION OF THE DRAWINGS

FIG. 1 depicts a communication device and one or more devices of a network such as a local wide area network (WLAN) 104;

FIG. 2 depicts a flowchart of an embodiment of a disclosed method; and

FIG. 3 depicts a flowchart of an example user interface process in accordance with an embodiment of a described method.

### DETAILED DESCRIPTION

A CIFS protocol to scan for CIFS shared directories does not always return reliable results. That is, not always are all local network domains resolved by a CIFS protocol scan. Additional time-consuming CIFS protocol scans may be required. Time constraints may leave some mobile communication device users without the opportunity to connect to otherwise available local servers. It would be beneficial were communication devices configured to provide users with the opportunity to connect to all available local servers.

Disclosed are a communication device and a method of a communication device that includes processing by the controller a first scan for shared drives and folders on a wide local area network in accordance with a CIFS Protocol and then processing a second scan for shared drives and folders of a local wide area network in accordance with an Address Resolution Protocol. An Address Resolution Protocol (ARP) is a computer network host's link layer or hardware address when only it's Internet Layer (IP) or Network Layer address is known. An ARP port scan is a low level request and answer protocol that uses a simple message format that contains one address resolution request or response. IP addresses are the result of an ARP port scan. In this way, user can be provided with the opportunity to connect to all available local servers.

The instant disclosure is provided to explain in an enabling fashion the best modes of making and using various embodiments in accordance with the present invention. The disclosure is further offered to enhance an understanding and appreciation for the invention principles and advantages thereof, rather than to limit in any manner the invention. While the preferred embodiments of the invention are illustrated and described here, it is clear that the invention is not so limited. Numerous modifications, changes, variations, substitutions, and equivalents will occur to those skilled in the art having the benefit of this disclosure without departing from the spirit and scope of the present invention as defined by the following claims.

It is understood that the use of relational terms, if any, such as first and second, up and down, and the like are used solely to distinguish one from another entity or action without necessarily requiring or implying any actual such relationship or order between such entities or actions.

Much of the inventive functionality and many of the inventive principles are best implemented with or in software programs or instructions and integrated circuits (ICs) such as application specific ICs. In the interest of brevity and minimization of any risk of obscuring the principles and concepts according to the present invention, discussion of such software and ICs, if any, is limited to the essentials with respect to the principles and concepts within the preferred embodiments.

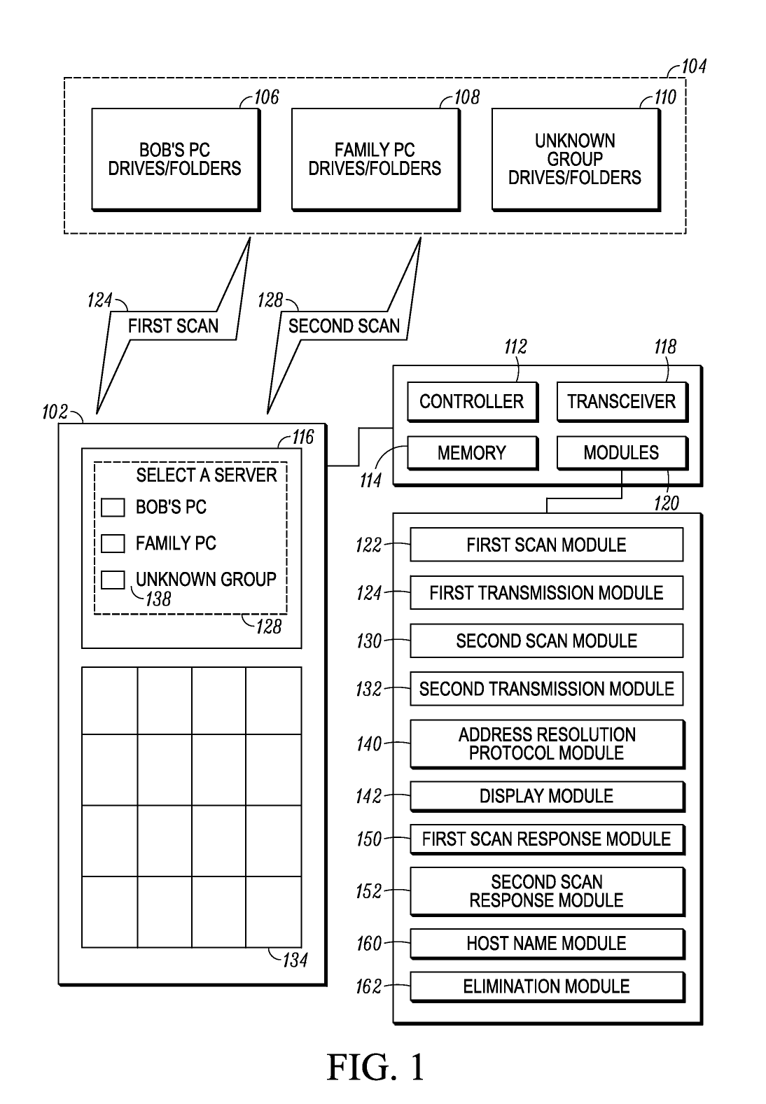

FIG. 1 depicts a communication device 102 and one or more devices of a network such as a local wide area network (WLAN) 104 including devices labeled as Bob's PC 106, Family PC 108 and a device of an Unknown Group 110. The Unknown Group 110 may or may not be present in the WLAN 104. As will discussed in more detail below, if there is one or more unknown drives/folders 110, it may be determined, and thus a user may have the opportunity to connect to all available local servers, including the Unknown Group 110.

The mobile communication device 102 may be implemented as a cellular telephone (also called a mobile phone). The mobile communication device 102 represents a wide variety of devices that have been developed for use within various networks. Such handheld communication devices include, for example, cellular telephones, messaging devices, personal digital assistants (PDAs), notebook or laptop computers incorporating communication modems, mobile data terminals, application specific gaming devices, video gaming devices incorporating wireless modems, and the like. Any of these portable devices may be referred to as a mobile station or user equipment. Herein, wireless communication technologies may include, for example, voice communication, the capability of transferring digital data, SMS messaging, Internet access, multi-media content access and/or voice over internet protocol (VoIP). The network 104 can be of course may be any type of wireless network including an ad hoc or wireless personal area network, a Wifi or wireless local area network, and a cellular or wireless wide area network.

The communication device includes a controller 112, a memory 114, display 116 and a transceiver 118. The memory can include modules 120. The modules can carry out certain processes of the methods as described herein. Steps of methods may involve modules and modules may be inferred by the methods discussed herein. The modules can be implemented in software, such as in the form of one or more sets of prestored instructions, and/or hardware, which can facilitate the operation of the mobile station or electronic device as discussed below. The modules may be installed at the factory or can be installed after distribution by, for example, a downloading operation. The operations in accordance with the modules will be discussed in more detail below.

As mentioned above, the Common Internet File System (CIFS) is the standard manner in which communication devices share files across intranets and the Internet. CIFS defines a remote file-access protocol that is compatible with the manner in which applications share data on local disks and network file servers. CIFS utilizes the Internet's global Domain Naming Service (DNS).

A first scan module 122 can be configured to enable processing by the controller 112 a first scan 124 for shared drives and folders on a local wide area network such as network 104 in accordance with a Common Internet File System Protocol. A first transmission module 126 configured to enable transmitting a first scan signal via the transceiver 118.

When the communication device 102 receives a response from one or more remote devices 106 and 108 of a scanned WLAN 104, the remote devices' host names, in this example, Bob's PC 106 and Family PC 108 can be annunciated by the communication device 102 by for example, its display 116. For example, upon scanning for domains, and then scanning for servers, if available shared drives and folders are determined, the servers' host names can be listed 128 on the communication device's display 116. A user may select a found server by checking a box on the display 116, or in any other manner, by voice control. Further authentication may be required for connection.

Either automatically, or by command, a second scan 128 may be processed for shared drives and folders of a local wide area network in accordance with an Address Resolution Protocol. An Address Resolution Protocol (ARP) is a computer network host's link layer or hardware address when only it's Internet Layer (IP) or Network Layer address is known. An ARP port scan is a low level request and answer protocol that uses a simple message format that contains one address resolution request or response. IP addresses are the result of an ARP port scan.

Accordingly, the second scan 128 of a second scan module 130 is configured to enable processing by the controller 112 for shared drives and folders of a local wide area network in accordance with an Address Resolution Protocol. A second transmission module 132 configured to enable transmitting a second scan signal via the transceiver 118. In this way, user can be provided with the opportunity to connect to all available local servers.

As mentioned the second scan 128 can be initiated automatically after the first scan 124 or by command. An Unknown Group 138 can be displayed by default so that a user can initiate by command the second scan 128 if desired. For example, a user can input a command via a keypad 134 to initiate the second scan 128. As mentioned the response of an ARP scan is not as user-friendly as the host name results of a CIFS domain scan. An Address Resolution Protocol module 140 configured for receiving a response to the second scan 128 via the transceiver 118 may or may not be able to provide a more user-friendly manner, such as a host name, in which to display the results of the second scan 128. The display module 142 can be configured for displaying on the display 116 a user notification of a response to the second scan 128. For example, a user notification of a response to the second scan 128 can be an IP address of the unknown device or group 110 with an available shared drive or folder.

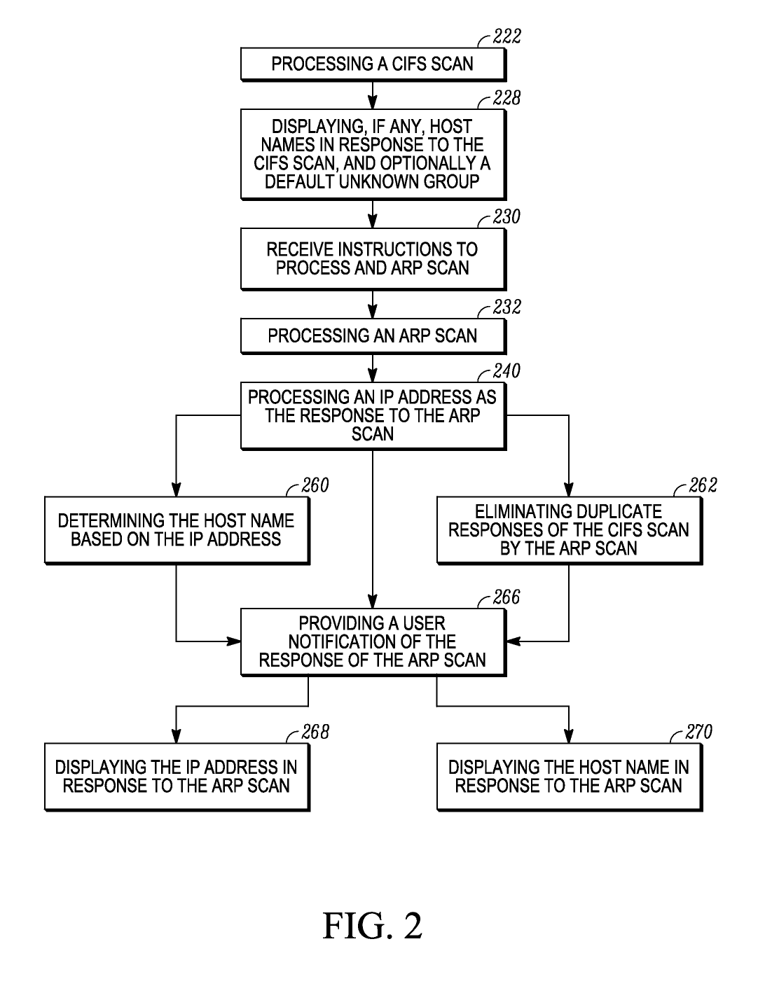

FIG. 2 depicts a flowchart of an embodiment of a disclosed method. A method can include processing 222 by the controller 112 (see FIG. 1) a first scan for shared drives and folders on a local network in accordance with a CIFS Protocol and displaying 228 on the display a first user notification of a response to the CIFS scan and optionally displaying on the display a second user notification of a default unknown group 138 (see FIG. 1).

As mentioned above, the instructions to process 230 an ARP scan may be automatic or user initiated. The processing 232 can include transmission of the ARP scan and receipt of a response to the scan. If an IP address is received 240 as a response to the ARP scan the Address Resolution Protocol module 140 (see FIG. 1) being configured for receiving a response to the second scan 128 via the transceiver 118 may or may not be able to provide a more user-friendly manner, such as a host name, in which to display the results of the second scan 128. In any event a first scan response module 150 can be configured to enable receiving a response to the first scan via the transceiver and a second scan response module 152 can be configured to enable receiving a response to the second scan via the transceiver wherein the response to the second scan provides a duplicate response of the first scan;

In either order or just one or the other, the host name based on the IP address may be determined 260 based on a received IP address in accordance with a host name module 160 (see FIG. 1) and/or there may be an elimination 262 of duplicate response of the CIFS scan by the ARP scan in accordance with the elimination module 162. A host name module 160, for example, may be configured to determine a host name based upon an IP address determined by the ARP scan if the network is NetBios supported. It is understood that any manner in which to determine a host name from an IP address, and visa versa is within the scope of this discussion. By determining an IP address from a host name or along with a host name, an elimination module may be able to enable eliminate the duplicate response of the first scan by the second scan that may be provided 266. Providing 266 a user notification of the response of the ARP scan via a display or any other suitable manner can include, for example, displaying the IP address 268 and/or displaying the host name in response to the ARP scan 270.

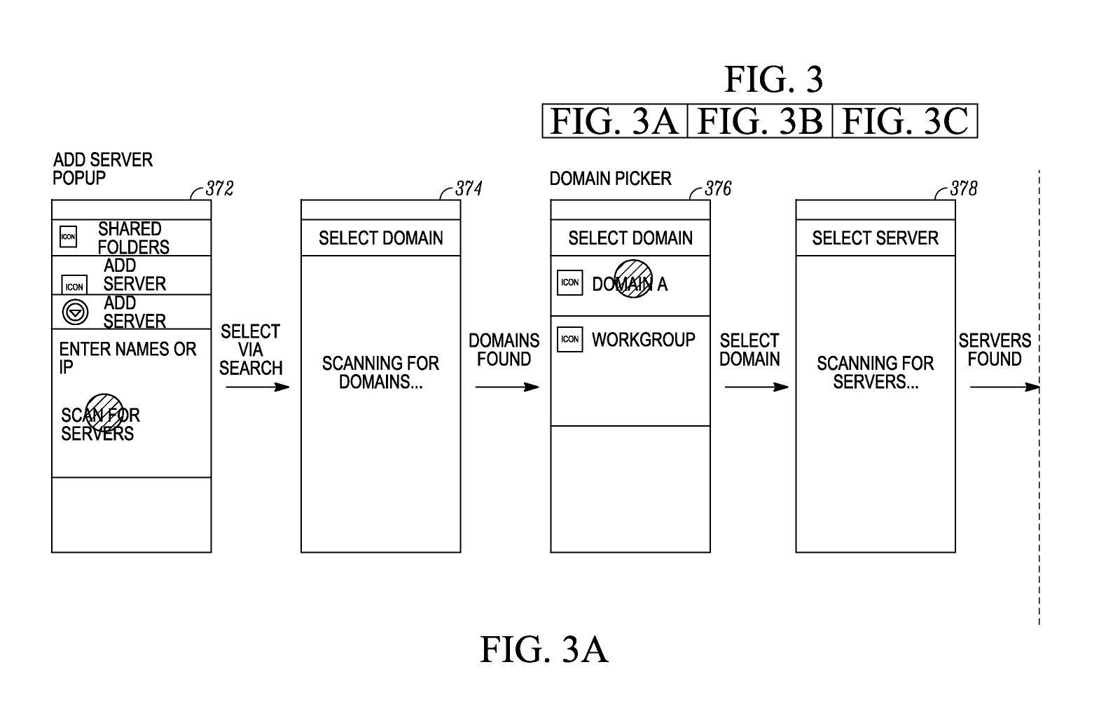

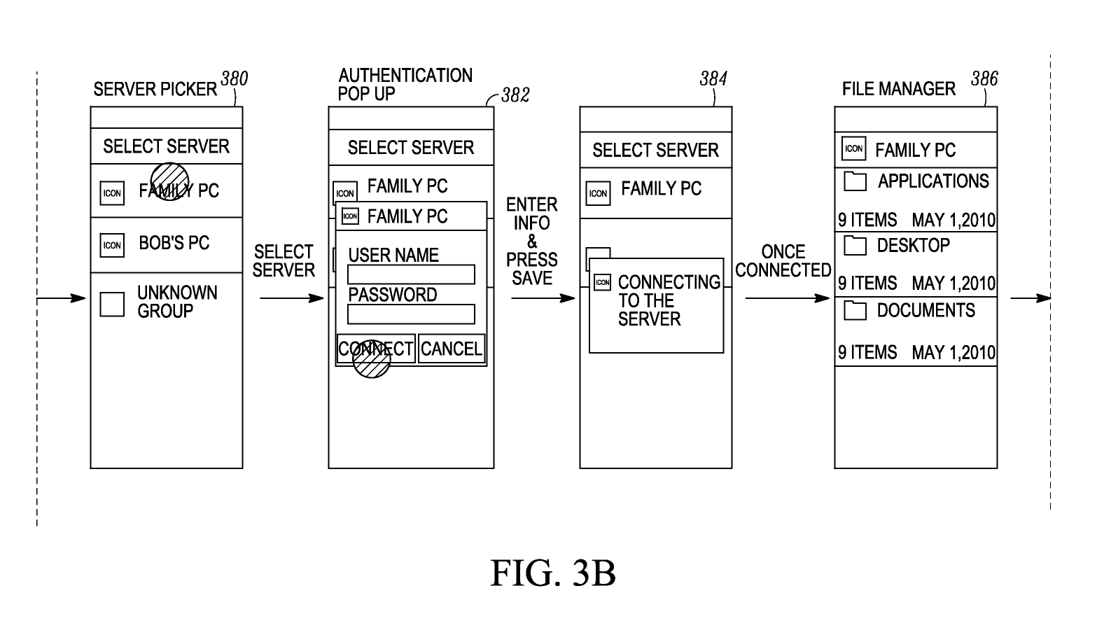

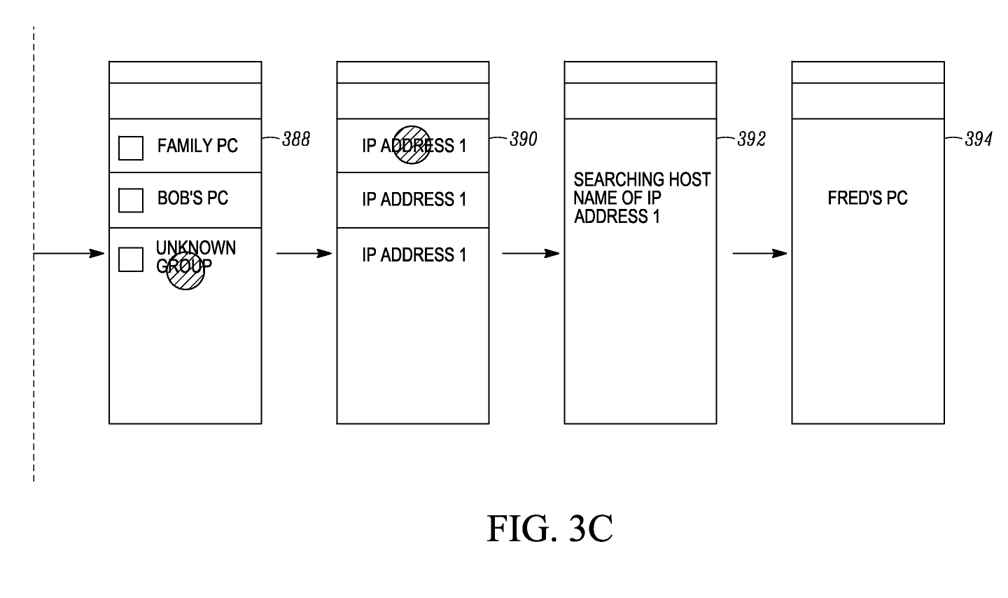

FIG. 3 depicts a flowchart of an example user interface process in accordance with an embodiment of a described method. The user interface 372 is a list dialog allowing a user to add a server to the device where the circle has indicated that the device such as one similar to the communication device 102 (see FIG. 1) should scan for devices. The user interface 374 shows that there can be an indication that the device is searching for domains of a local network. The user interface 376 shows that two domains have been found and that populated a list. The user interface 378 shows that once a domain is selected, the device can scan for servers. As discussed above, this scan would be a CFIS scan. Once servers are found, the user interface 380 would provide a populated list which is similar to that which is shown in FIG. 1. In this case, the Family PC 108 may be selected. As mentioned above, a second scan, under a ARP protocol can automatically take place, or can be user initiated. The user interface 382 shows an authentication pop-up which is a text entry dialog. If a user name and/or password is required, the authentication popup will appear. The user interface 384 can show that the device is connecting to the Family PC server. The user interface 386 depicts a file manager where the entered server is added to the list of saved servers and is opened.

As mentioned above, in the event that a second scan is user under a RAP protocol can be initiated as depicted by user interface 368, the user interface 390 may show IP addresses. One or more of those IP addresses 1, 2 and 3 may duplicate the servers found in the scan that produced user interface 380. There may be an option such as depicted in user interface 392 that allows the device to search for the host name of a selected IP address. In that case, the host name may be provided as shown in user interface 394. Whether or not the host name is available based upon the IP address, In this way, user can be provided with the opportunity to connect to all available local servers in accordance with the ARP scan in addition to the CIFS scan.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) was chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally and equitably entitled.

1. A method of a communication device having a controller, a memory, display and a transceiver, the method comprising:
processing by the controller a first scan for shared drives and folders on a local network in accordance with a Common Internet File System Protocol;
transmitting a first scan signal via the transceiver;
processing by the controller a second scan for shared drives and folders of a local network in accordance with an Address Resolution Protocol; and
transmitting a second scan signal via the transceiver.

2. The method of claim 1, further comprising:
receiving a response to the second scan via the transceiver;
displaying on the display a user notification of a response to the second scan.

3. The method of claim 2, wherein displaying on the display a user notification of a response to the second scan comprises:
displaying an IP address of the device with an available shared drive or folder.

4. The method of claim 2, wherein receiving a response to the second scan via the transceiver comprises:
receiving an IP address; and
wherein the method further comprises:
determining a host name from the IP address.

5. The method of claim 4, wherein displaying on the display a user notification of a response to the second scan comprises:
displaying a hostname of the device with an available shared drive or folder.

6. The method of claim 1, further comprising:
receiving a response to the first scan via the transceiver;
displaying on the display a first user notification of a response to the first scan;
receiving a response to the second scan via the transceiver; and
displaying on the display a second user notification of a response to the second scan.

7. The method of claim 1
receiving a response to the first scan via the transceiver;
receiving a response to the second scan via the transceiver wherein the response to the second scan provides a duplicate response of the first scan;
displaying on the display a user notification of a response to the first scan; and
eliminating the duplicate response of the first scan by the second scan when displaying on the display a user notification of a response to the second scan.

8. A communication device having a controller, a memory, display and a transceiver, comprising:
a first scan module configured to enable processing by the controller a first scan for shared drives and folders on a local wide area network in accordance with a Common Internet File System Protocol;
a first transmission module configured to enable transmitting a first scan signal via the transceiver;
a second scan module configured to enable processing by the controller a second scan for shared drives and folders of a local wide are network in accordance with an Address Resolution Protocol; and
a second transmission module configured to enable transmitting a second scan signal via the transceiver.

9. The device of claim 8, further comprising:
an Address Resolution Protocol module configured for receiving a response to the second scan via the transceiver;
a display module configured for displaying on the display a user notification of a response to the second scan.

10. The device of claim 9, wherein a user notification of a response to the second scan comprises:
an IP address of the device with an available shared drive or folder.

11. The device of claim 9, wherein a response to the second scan via the transceiver comprises:
a receipt of an IP address; and
wherein the device further comprises:
a host name module configured for determining a host name from the IP address.

12. The device of claim 11, wherein the display a user notification of a response to the second scan comprises:
a host name of the device with an available shared drive or folder.

13. The device of claim 8, further comprising:
a first scan response module configured to enable receiving a response to the first scan via the transceiver;
a second scan response module configured to enable receiving a response to the second scan via the transceiver; and
a display module configure for displaying on the display a first user notification of a response to the first scan and a second user notification of a response to the second scan.

14. The device of claim 8, further comprising:
a first scan response module configured to enable receiving a response to the first scan via the transceiver;
a second scan response module configured to enable receiving a response to the second scan via the transceiver wherein the response to the second scan provides a duplicate response of the first scan;
an elimination module configured to enable eliminating the duplicate response of the first scan by the second scan; and
a display module configure for displaying on the display a first user notification of a response to the first scan and a second user notification of a response to the second scan.

15. A method of a communication device having a controller, a memory, display and a transceiver, the method comprising:
processing by the controller a first scan for shared drives and folders on a local network in accordance with a Common Internet File System Protocol;
transmitting a first scan signal via the transceiver;
receiving a response to the first scan via the transceiver;
displaying on the display a first user notification of a response to the first scan; and
displaying on the display a second user notification of a default unknown group.

16. The method of claim 15, comprising:
receiving input related to the second user notification of a default unknown group;
processing by the controller a second scan for shared drives and folders of a local network in accordance with an Address Resolution Protocol in response to the second notification of a default unknown group;
transmitting a second scan signal via the transceiver;
receiving a response to the second scan via the transceiver; and
displaying on the display a third user notification of a response to the second scan.

17. The method of claim 16, wherein displaying on the display the third user notification of a response to the second scan comprises:
displaying an IP address of the device with an available shared drive or folder.

18. The method of claim 16, wherein receiving a response to the second scan via the transceiver comprises:
receiving an IP address; and
wherein the method further comprises:
determining a host name from the IP address.

19. The method of claim 16, wherein displaying on the display the third user notification of a response to the second scan comprises:
displaying a host name of the device with an available shared drive or folder.
